(19) United States
(12) Patent Application Publication
(10) Pub. No.: US 2009/0284837 A1
(43) Pub. Date: Nov. 19, 2009

(54) Method and apparatus providing uniform separation of lens wafer and structure bonded thereto

(75) Inventors: Rick Lake, Meridian, ID (US); Shashikant Hegde, Boise, ID (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 12/153,074

(22) Filed: May 13, 2008

(51) Int. Cl. G02B 27/10; B29D 11/00

(52) U.S. Cl. 359/619; 264/1.1; 425/470

(57) ABSTRACT

Methods and apparatus providing a master wafer having standoffs to control a bondline thickness between one wafer produced indirectly from the master wafer and another wafer bonded to the produced wafer. Standoffs may be formed as a single standoff, standoff walls, or as a number of discrete standoffs. The standoffs provide a balanced support base and a uniform spacing between the one wafer and another wafer bonded thereto.

### FIELD OF THE INVENTION

The invention relates generally to the field of wafer level package formation, and more specifically to methods used in attaching a wafer containing a lens to a wafer containing an imager die.

### BACKGROUND

A common technique of forming imaging device lenses uses a master wafer having a plurality of lens shapes formed on a surface to form an intermediate negative sub-master wafer, and subsequently uses the sub-master wafer as a lens stamp to form a plurality of lenses across a lens wafer. The lens wafer is often made of glass or other transparent substrate and is covered by a layer of lens material, for example, an acrylic polymer or other optical polymer. By pressing the sub-master wafer into the lens material, the lens shapes of the master wafer are replicated across the surface of the lens wafer. After removing the sub-master wafer, the lens wafer will have lens shapes formed in the lens material forming lens structures at locations across the wafer. The lens wafer may then be stacked atop or otherwise attached to an imager wafer containing imager dies provided at locations across the imager wafer. The imager wafer and lens wafer are aligned such that a lens is structurally positioned directly above each imager die. In order to set the proper focal length of the lens wafer, a spacer wafer may be placed between the lens wafer and the imager wafer. The thickness of the spacer wafer determines the distance between the lens wafer and the imager wafer. The joined lens wafer, spacer wafer, and imager wafer may further include additional attached wafer layers, such as additional lens wafers or filters. After all desired wafer level elements are attached together, the wafer assembly is subsequently cut to form individual imager modules for use in cameras and other imaging devices.

In the course of mass manufacturing lenses in the above described manner, the vertical proximity of the lens wafer to the conjoined imager wafer should be ideally uniform in order to preserve consistency of lens structure focal lengths among the imager modules. In order to achieve this, various checks and controls may be instituted at various processing steps.

Two particular variables that must be controlled are the horizontal alignment of one wafer with another and the vertical spacing between one wafer and another. For example, to ensure a consistent focal point positioning for all lens structures positioned in respective imager modules, the lens wafer needs to be consistently spaced the same amount from the imager die wafer across the entirety of both wafers. Tilting of one wafer with respect to the other will result in an undesired deviation in focal distance across the imager modules.

A spacer wafer, as previously mentioned, is one way to set the focal lengths between the imager wafer and the lens wafer. The spacer wafer is often attached to the lens wafer using an adhesive, for example, an epoxy layer. A problem arises in ensuring that the epoxy bondline is uniform in thickness. If there is a different thickness in the epoxy bondline, the lens wafer which is attached to the imager wafer through the spacer wafer may not be in precise horizontal alignment with the adjoining image wafer. Spacer beads of uniform diameter can be mixed in the epoxy to control the epoxy bondline thickness, however, spacer beads can be expensive to manufacture, are limited in range of size, and are fragile. If too much pressure is exerted in pressing the spacer wafer against the lens wafer during attachment, the spacer beads may break. A more customizable, durable and less costly way of controlling the epoxy bondline thickness in wafer level fabrication is desirable.

### BRIEF DESCRIPTION OF THE DRAWINGS

FIG. 1 shows a master wafer having standoffs and lens shapes formed therein.

FIG. 2 shows a sub-master wafer having standoff dies and lens dies formed therein.

FIG. 3 shows a cross-sectional side view of a sub-master wafer being pressed into a lens material deposited on a surface of a lens wafer.

FIG. 4 shows a cross-sectional side view of the lens wafer of FIG. 3 having standoffs and lenses formed thereon.

FIG. 5A shows a master wafer having a standoff wall formed therein.

FIG. 5B shows a sub-master wafer formed from the master wafer of FIG. 5A.

FIG. 5C shows a master wafer having another configuration of a standoff wall formed therein.

FIG. 5D shows a master wafer having yet another configuration of a standoff wall formed therein.

FIG. 6 shows a top view of a master wafer having standoffs formed therein positioned as alignment marks.

FIG. 7 shows a top view of a master wafer having a plurality of standoffs populating a surface of the master wafer positioned in columns which alternate with columns of lenses.

FIG. 8 shows a cross-sectional side view of a lens wafer having standoffs formed thereon with an adhesive deposited over the standoffs.

FIG. 9 shows a cross-sectional side view of the lens wafer of FIG. 8 having a spacer wafer attached to the standoffs.

FIG. 10 shows a cross sectional side view of a lens wafer having standoffs formed on both sides.

FIG. 11 shows a cross sectional side view of an imager module having wafer level optics stack incorporating standoffs.

### DETAILED DESCRIPTION OF THE INVENTION

In the following detailed description, reference is made to the accompanying drawings which form a part hereof, and which illustrate specific embodiments that may be practiced. These embodiments are described in sufficient detail to enable those of ordinary skill in the art to make and use them. It is also understood that structural, logical, or procedural changes may be made to the specific embodiments disclosed herein.

In one embodiment, standoffs are used control the epoxy bondline thickness between a spacer wafer and an adjoining lens wafer. The standoffs may be formed in various ways including, but not limited to, being integrally formed in a lens master wafer which is used to create a negative sub-master, which in turn is used to produce a lens wafer having standoffs. Furthermore, standoffs may be formed in various shapes, sizes, patterns and layouts.

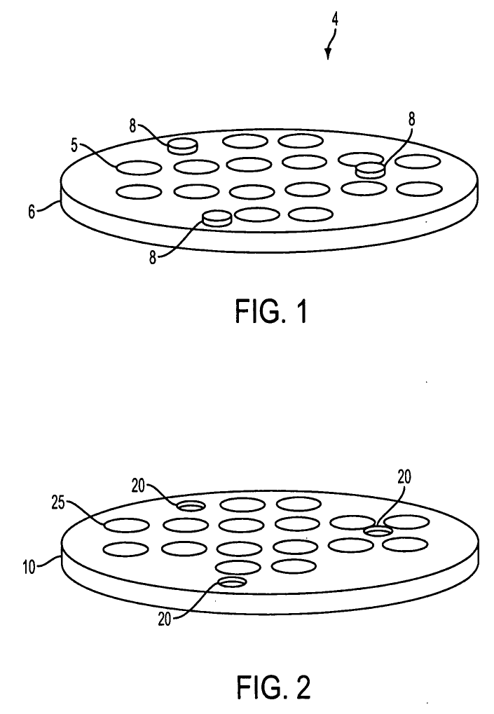

Referring now to the drawings, where like elements are designated by like reference numerals, FIG. 1 shows an embodiment of a master wafer 4 having integral standoffs 8 and lens shapes 5 formed on a surface of a substrate 6. The substrate 6 may comprise a wafer of silicon, metal, or any other suitable material for use in wafer level fabrication processes. The standoffs 8 may be formed on the substrate 6 through the same conventional techniques used to form lens shapes 5 on the master wafer 4, and using the same material used to form the lens shapes. Such techniques, including photolithography, etching and other methods, are well known in the art and will not be discussed further here.

The standoffs 8 may be created having a uniform height for controling an adhesive bondline thickness in a subsequently produced lens wafer. The exact size of the standoffs 8 may vary as required for a specific application. Generally, a desired range of the standoff 8 size is approximately 10-300 μm in height with a round diameter of about 0.5-1.5 mm.

In the embodiment shown in FIG. 1, three standoffs 8 are positioned in a tripod layout configuration. By using only three standoffs 8 in this layout, the standoffs 8 may be incorporated into a master wafer 4 relatively easily and at low cost. It should be understood that the master wafer 4 may be constructed having a different number of standoffs 8 ranging from one to a larger number of standoffs 8, for example, up to the number of lenses on the master wafer 4 or more. Likewise, although the standoffs 8 are illustrated in a tripod layout, other positioning may be employed; all that is required is that the configuration provides for a balanced support base for stacking additional wafers thereupon when the standoffs are formed on a lens wafer.

As is known in the art, the master wafer 4 is used to create a negative stamping template, also referred to as a sub-master wafer. The master wafer 4 may be used to create the sub-master wafer through any of various known techniques, including but not limited to depositing a plating film comprising nickel or some other suitable material on the master wafer 4 to form an intermediate negative sub-master wafer. Other known techniques include pressing the master wafer 4 into a moldable material to form a sub-master wafer. Still other known techniques include depositing an ultraviolet curable or thermally curable polymer material onto the master wafer 4 and replicating the master wafer 4 using known replication techniques to form a sub-master wafer. Alternatively, a sub-master wafer may be created directly without the use of a master wafer 4 by diamond turning or other known techniques.

It should be noted that when a master wafer 4 is used to produce a sub-master wafer which is in turn used to produce a lens wafer, that the produced lens wafer will have the exact same lens shape and standoff configuration as in the master wafer 4. Thus, FIG. 1 depicts both master wafer 4 as well as a resulting lens wafer.

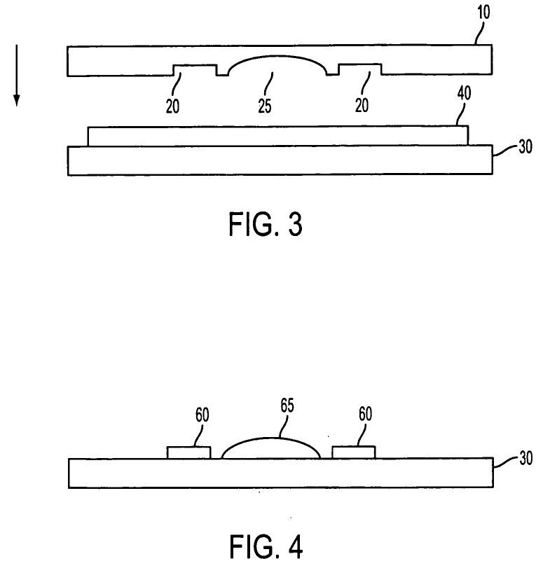

FIG. 2 shows an embodiment of a sub-master wafer 10 having a plurality of standoff dies 20 and lens dies 25 created using and corresponding to the master wafer 4 standoffs 8 and lens shapes 5. The sub-master wafer 10 is used as a stamp to form lens wafers, as is known in the art. Referring to FIGS. 3 and 4, which show a cross sectional view of a stamping operation using a portion of a sub-master wafer 10, the sub-master wafer 10 is pressed into lens material 40 formed on a surface of a lens wafer 30 to form lenses 65 on the lens wafer 30 which correspond to the lens dies 25 on the sub-master wafer 10. The standoff dies 20 on the sub master wafer 10 will form standoffs 60 on the lens wafer 30 simultaneously with the lens 65 formation. The completed position of a lens wafer 30 having both lenses 65 and standoffs 60 is shown in FIG. 4.

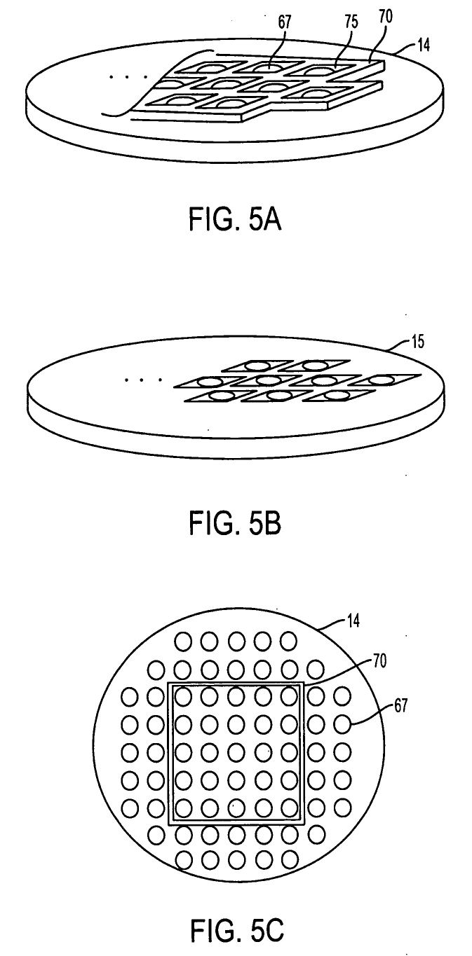

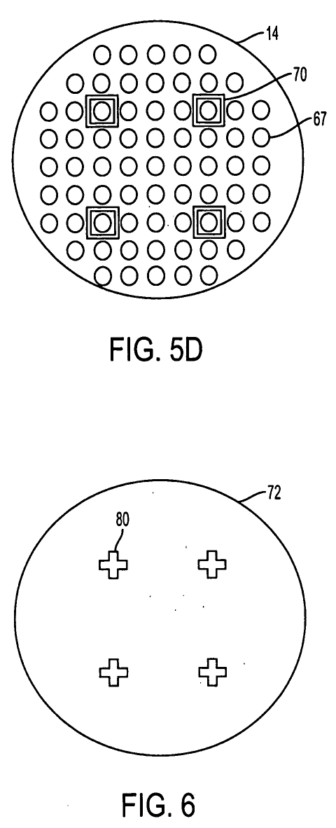

Standoffs may be formed in various shapes, including but not limited to cylindrical, spherical, rectangular or other shapes. Standoffs may alternatively be formed as an interconnected raised wall. In an embodiment shown in FIG. 5, standoff walls 70 are formed on a master wafer 14 encompassing lens shapes 67 in adjoining perimeters. In this embodiment, the lens shapes 67 occupy a space 75 enclosed by a perimeter of a standoff wall 70. The master wafer 14 shown in FIG. 5 can then be used to form a sub-master wafer 15 (FIG. 5B), which in turn can be used to form lenses and associated wall standoffs in a lens wafer, using, for example, the process shown in FIGS. 3 and 4. The standoff wall 70 of master wafer 14 may be designed in various ways, including but not limited to a standoff wall 70 encompassing a group of lenses collectively (FIG. 5C), encompassing select lenses individually (FIG. 5D), or encompassing each individual lens respectively.

In addition to having different shapes, standoffs may also be formed in various positional layouts. In an embodiment shown in FIG. 6, standoffs 80 are formed on a master wafer 72 as cross-shaped alignment marks positioned to provide marking for aligning a stamped lens wafer with other wafers for wafer stacking purposes.

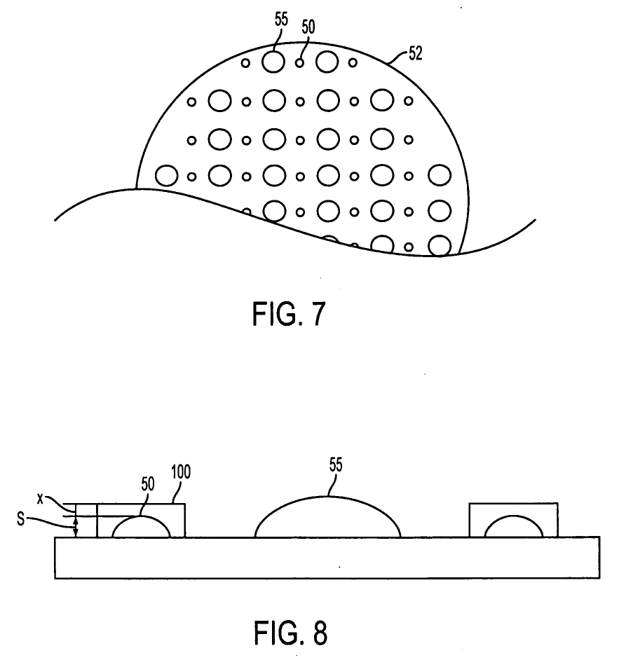

The number of standoffs may vary as desired. For example, to further increase the stability and uniformity of the bondline thickness, the number of standoffs can be increased as shown in FIG. 7. In this embodiment, the standoffs 50 are included throughout the master wafer 52 arranged in columns alternating with columns of lens shapes 55. The lens wafer formed using master wafer 52 and a negative sub-master wafer looks identical to master wafer 52 and therefore is also illustrated by FIG. 7.

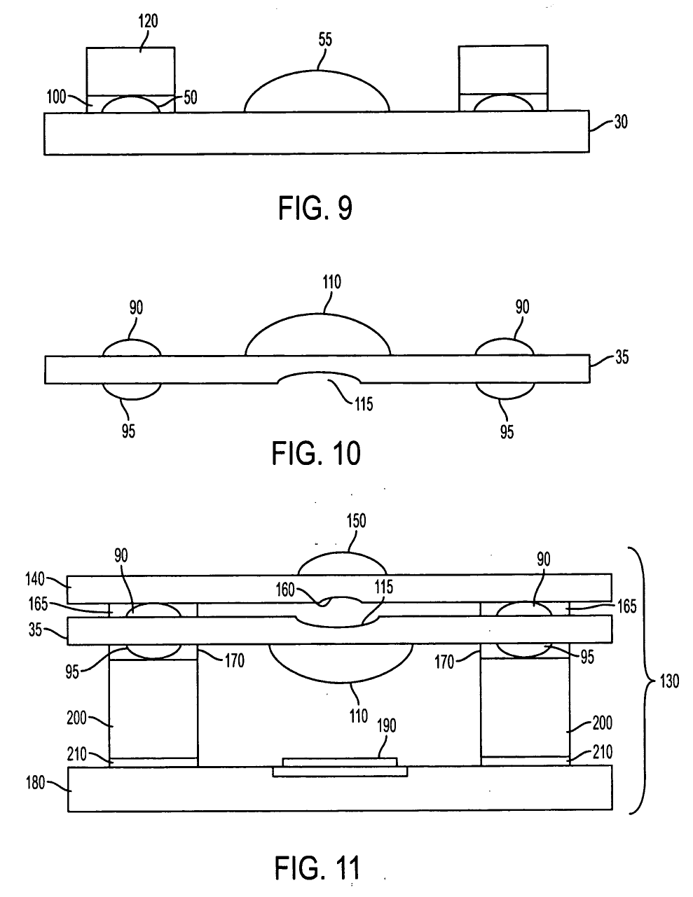

Use of the standoffs in attaching a spacer wafer to a lens wafer is illustrated in FIG. 8, which shows a sectional side view of a lens wafer 30 formed using and corresponding to the master wafer 52 of FIG. 7. The standoff 50 height S may be, for example, within the range of 10-300 μm. An adhesive for example, an epoxy 100, is deposited in areas of the lens wafer outside areas where the lenses 55 are present. The epoxy is provided over the standoffs 50 such that an excess amount X remains above the standoff 50. FIG. 9 shows the application of the spacer wafer 120 to the lens wafer 30. The spacer wafer 120 is pressed into the epoxy 100 towards the lens wafer 30. Due to the standoffs 50, the bondline thickness of the epoxy 100 is uniformly equal to the height S (FIG. 8) of the standoff 50, across the entirety of the spacer wafer and lens wafer.

Standoffs may also be incorporated on one or both sides of a lens wafer. As shown in FIG. 10, a lens wafer 35 may be formed having lenses on both sides and may be attached to other wafer level structures, such as another lens wafer. As shown in FIG. 10, as one example, a convex lens 110 can be produced on one side of a lens wafer 35, a concave lens 115 on the other side, and accompanying standoffs 90 on one side and standoffs 95 on the other side. Lens wafer 35 is suitable for use in multiple level waver level packaging of imager modules.

FIG. 11 shows an embodiment of a imager module 130 having wafer level optics stack incorporating standoffs 90,95 as described above. Imager module 130 comprises two lens wafers 140 and 35, a spacer wafer 200, and an imager circuit wafer 180. In this embodiment, a first lens wafer 140 is on the top of the imager module 130 stack. Lens wafer 140 includes convex lens 150 on one side and concave lens 160 on the other side, and is positioned directly above lens wafer 35 such that lenses 150,160 are in vertical alignment with lenses 110,115 along a common focal axis. A second lens wafer 35 is positioned between the first lens wafer 140 and the spacer wafer 200 in the imager module 130 stack. The second lens wafer includes convex lens 110 on one side, concave lens 115 on the other side, and standoffs 90, 95 on either side, to control the bondline thickness in adhesive layers 165, 170 between lens wafer 140, 35 bonding areas. Spacer wafer 200 is positioned between the second lens wafer. 135 and the imager circuit wafer 180. Spacer wafer 200 is attached to imager circuit wafer 180 through adhesive layer 210. Imager circuit wafer 180 is positioned at the bottom of imager module 130 stack, and includes an imager circuit having a pixel array 190 for capturing a digital image through light received through lenses 110, 115, 150, and 160.

It should be noted that although FIG. 11 shows a cross section of an imager module incorporating standoffs at the bonding areas between the lens wafers 140,135, other cross-sections may show attachments at bonding areas that comprise an adhesive layer without standoffs 90, 95, the adhesive layer having a thickness uniform to the height of the standoffs 90, 95.

Standoffs 90, 95 provide a uniform horizontal alignment among lens wafers 140, 35 and spacer wafer 200, thereby helping to place the focal points of the lenses 110, 115, 150, and 160 at the desired locations to provide incoming light to the imager circuit 190. Although the two lens wafers 140, 35 are shown, an imager module may be formed having additional lens wafers added to the stack, as well as other layers including color filter arrays, light shields or other layers. Furthermore, standoffs need not be formed on both sides of a lens wafer. Alternatively, standoffs may be formed on one side a lens wafer and, as previously described, may additionally by designed to serve as alignment marks to aid in aligning lens wafer stacks.

It should be noted that the type of lens shown for the lens wafers, e.g., 110, 115, 150, and 160, in the various embodiments described are merely exemplary as many different lens designs, shapes and lens materials may be used for a particular imager application.

While embodiments have been described in detail, it should be readily understood that they are not limited to the disclosed embodiments. Rather the embodiments can be modified to incorporate any number of variations, alterations, substitutions or equivalent arrangements not heretofore described. Accordingly, the invention is not limited by the described embodiments, but is only limited by the scope of the appended claims.

What is claimed as new and desired to be protected by Letters Patent of the United States is:

1. A master lens wafer used in forming a lens wafer, the mater lens wafer comprising:
a substrate;
a plurality of lens shapes formed on the substrate; and,
at least one standoff formed on the surface of the substrate for limiting adhesive thickness when a lens wafer formed using the master lens wafer is bonded to another wafer.

2. The master lens wafer of claim 1, wherein the at least one standoff comprises a plurality of standoffs formed at designated bonding areas.

3. The master lens wafer of claim 2, wherein the plurality of standoffs are formed having a uniform height.

4. The master lens wafer of claim 2, wherein the plurality of standoffs comprise at least three standoffs positioned in a tripod configuration.

5. The master lens wafer of claim 2, wherein the plurality of lens shapes are formed in columns and the plurality of standoffs are formed in columns, where columns of standoffs alternate with columns of lens shapes.

6. The master lens wafer of claim 2, wherein the plurality of standoffs are positioned at predetermined locations and further function as wafer alignment markers.

7. The master lens wafer of claim 6, wherein the plurality of standoffs are cross-shaped.

8. A sub-master wafer for forming a lens wafer, comprising:
a substrate;
a plurality of lens dies formed on a surface of the substrate; and
at least one standoff die, wherein the plurality of lens dies and at least one standoff die are configured to form lenses and at least one standoff in a lens wafer.

9. The apparatus of claim 8, wherein the at least one standoff die comprises a standoff wall die positioned such that at least one lens die is within an at least a partial perimeter of the standoff wall

10. The apparatus of claim 8, wherein the standoff wall die is formed in a closed position and at level one lens die is positioned within said enclosed perimeter.

11. A lens wafer, comprising:
a wafer;
a plurality of lenses integrally formed on a surface of the wafer; and
at least one standoff formed on the surface of the wafer for limiting an adhesive thickness at bonding areas when the wafer is bonded to another wafer.

12. The lens wafer of claim 12, wherein the at least one standoff comprises a plurality of standoffs positioned in predetermined locations and further serve as alignment marks.

13. The lens wafer of claim 11, wherein the at least one standoff comprises a wall forming a perimeter encompassing at least one lens.

14. The lens wafer of claim 11, wherein:
the plurality of lenses are formed in columns;
the at least one standoff comprises a plurality of standoffs arranged in columns; and
the columns of standoffs alternate with the columns of lenses.

15. The lens wafer of claim 11, wherein the at least one standoff is formed having a height ranging from about 70 μm to 300 μm.

16. A method of forming a master wafer, comprising:
forming a plurality of lens shapes on a surface of a wafer; and
forming at least one standoff on the surface of the wafer for controlling the spacing of a lens wafer produced using the master wafer from another wafer bonded to the lens wafer.

17. The method of claim 16, wherein the plurality of standoffs are formed having a height ranging from 70 μm to 300 μm.

18. The method of claim 16, further comprising:
forming an intermediate sub-master wafer from the master wafer; and
forming a lens wafer from the sub-master wafer, wherein the plurality of standoffs are formed in locations on the master wafer such that the plurality of standoffs formed on the lens wafer provide a balanced support base for attaching another wafer to the lens wafer.

19. A method of forming a lens attachment structure., comprising:
forming a plurality of lenses and a plurality of standoffs of uniform height on a surface of a first lens wafer;
depositing an adhesive over the plurality of standoffs; and
placing a first side of another wafer in contact with the standoffs.

20. The method of claim 19, wherein said another wafer is a spacer wafer, the method further comprising attaching a second side of the spacer wafer to an imager die wafer.

21. The method of claim 19, wherein the adhesive is an epoxy.

22. The method of claim 19, wherein the plurality of standoffs are formed dispersed across the wafer surface and positioned in columns.

23. The method of claim 19, further comprising forming the standoffs in a configuration that provides a balanced support base for the spacer wafer.

24. The method of claim 19, wherein the standoffs are formed of the same material as the lenses.

25. The method of claim 19, wherein the standoffs are formed simultaneously with the formation of the lenses.

26. The method of claim 19, further comprising:
forming a second plurality of standoffs on a second surface of the first lens wafer;
depositing an adhesive over the second plurality of standoffs; and
placing a first side of a second lens wafer in contact with the second plurality of standoffs.
